(19) United States
(12) Patent Application Publication
(10) Pub. No.: US 2020/0074070 A1
(43) Pub. Date: Mar. 5, 2020

(54) RISK BASED TIME-BASED ONE-TIME PASSWORD (TOTP) AUTHENTICATOR

(71) Applicant: Michael Boodaei, Givatayim (IL)

(72) Inventor: Michael Boodaei, Givatayim (IL)

(21) Appl. No.: 16/175,893

(22) Filed: Oct. 31, 2018

Related U.S. Application Data
(63) Continuation of application No. 16/114,299, filed on Aug. 28, 2018, now abandoned.

(51) Int. Cl. G06F 21/45; H04L 29/06

(52) U.S. Cl. CPC G06F 21/45; H04L 63/0838; H04L 63/0846

(57) ABSTRACT

A computer implemented method of generating a Time based One Time Password (TOTP) comprising a risk assessment index comprising, monitoring an authentication process in which a user provides authentication credentials to enable the code generation device to generate a TOTP for use by a client device associated with the user to access a secure service, calculating a risk index indicating an estimated risk level of the authentication process based on data collected during the authentication process, generating the TOTP based on a unique secret key assigned to the code generation device and a current time, the TOTP is encoded to encode the risk index and outputting the encoded TOTP for transmission to an authentication system adapted to generate an authentication score for the user attempting to access the secure service based on verification of the TOTP and according to the risk index.

### RELATED APPLICATION(S)

This application is a Continuation of U.S. patent application Ser. No. 16/114,299, filed on Aug. 28, 2018, the contents of which are incorporated by reference as if fully set forth herein in their entirety.

### FIELD AND BACKGROUND OF THE INVENTION

The present invention, in some embodiments thereof, relates to generating a TOTP for authenticating a user using a client device for accessing a secure service, and, more specifically, but not exclusively, to generating a TOTP encoded with a risk index calculated for an authentication process of a user using a client device for accessing a secure service.

Access to online resources is often subject to user authentication in which the user is required to provide evidence to prove his identity. Such authentication may be a major concern when accessing secure services, secure systems, secure platforms and/or the like such as, for example, an online finance service (e.g. a banking service, a credit/debit card service, etc.), a remote access system, an entertainment content streaming service and/or the like. The user authentication may be carried out by a plurality of methods, techniques and/or implementations

One of the most commonly used authentication methods is the TOTP. In the TOTP scheme, a code generation device associated with the user generates a TOTP code (e.g. a sequence of numbers and/or digits) based on the current time of the TOTP generation (timestamp) and a unique secret key assigned to each code generation device. As such a unique TOTP may be generated at any given time by each code generation device.

When accessing the secure service, the user is requested to provide a TOTP and may operate the code generation device to generate the TOTP based on a unique secret key assigned to the (specific) code generation device. Operating the code generation device typically requires the user to authenticate himself by providing authentication credentials to enable (e.g. launch, unlock, etc.) the code generation device.

An authentication system associated with the secure service may validate the identity of the user by locally generating a TOTP based on the unique secret key of the (specific) code generation device retrieved from a database mapping each of a plurality of code generation devices to one or more unique secret keys and comparing the received TOTP to the locally generated TOTP. In case of a match, the user may be validated and granted access to the secure service while in case of no match the user may be denied access to the secure service. To ensure security and robustness of the authentication process the TOTP code may expire (become invalid) after a predefined time period from the time the TOTP was generated to prevent usage of previously generated TOTP codes.

### SUMMARY OF THE INVENTION

According to a first aspect of the present invention there is provided a computer implemented method of generating a TOTP comprising a risk assessment index, comprising using one or more processors of a code generation device for:
Monitoring an authentication process in which a user provides authentication credentials to enable the code generation device to generate a TOTP for use by a client device associated with the user to access a secure service.
Calculating a risk index indicating an estimated risk level of the authentication process based on data collected during the authentication process.
Generating the TOTP based on a unique secret key assigned to the code generation device and a current time, the TOTP is encoded to encode the risk index.
Outputting the encoded TOTP for transmission to an authentication system adapted to generate an authentication score for the user attempting to access the secure service based on verification of the TOTP and according to the risk index.

According to a second aspect of the present invention there is provided a code generation device for generating a TOTP comprising a program store storing a code and one or more processors coupled to the program store for executing the stored code. The code comprising:
Code instructions to monitor an authentication process in which a user provides authentication credentials to enable the code generation device to generate a TOTP for use by a client device associated with the user to access a secure service.
Code instructions to calculate a risk index indicating an estimated risk level of the authentication process based on data collected during the authentication process.
Code instructions to generate the TOTP based on a unique secret key assigned to the code generation device and a current time, the TOTP is encoded to encode the risk index.
Code instructions to output the encoded TOTP for transmission to an authentication system adapted to generate an authentication score for the user attempting to access the secure service based on verification of the TOTP and according to the risk index.

According to a third aspect of the present invention there is provided a computer implemented method of authenticating a user attempting to access a secure service according to a TOTP comprising a risk assessment index, comprising using one or more processors of an authentication system for:
Receiving an encoded TOTP from a client device associated with a user. The encoded TOTP is generated by a code generation device associated with the client device during an authentication process in which the user provides his authentication credentials to enable the code generating device to generate a TOTP for accessing a secure service. The TOTP which is based on a unique secret key assigned to the code generation device and a current time is encoded with a risk index to produce the encoded TOTP. The risk index calculated by the code generation device based on data collected from the client device is indicative of an estimated risk level of the authentication process.
Decoding the encoded TOTP to extract the risk index and verify the TOTP.
Calculating an authentication score based on verification of the TOTP and according to the risk index.
Outputting the authentication score to one or more systems adapted to grant the client device access to the secure service according to the authentication score.

According to a fourth aspect of the present invention there is provided a system for authenticating a user accessing a secure service according to a TOTP comprising a risk assessment index, comprising a program store storing a code and one or more processors coupled to the program store for executing the stored code. The code comprising:
Code instructions to receive encoded TOTP from a client device associated with a user. The encoded TOTP is generated by a code generation device associated with the client device during an authentication process in which the user provides his authentication credentials to enable the code generating device to generate a TOTP for accessing a secure service. The TOTP which is based on a unique secret key assigned to the code generation device and a current time is encoded with a risk index to produce the encoded TOTP. The risk index calculated by the code generation device based on data collected from the client device is indicative of an estimated risk level of the authentication process.
Code instructions to decode the encoded TOTP to extract the risk index and verify the TOTP.
Code instructions to calculate an authentication score based on verification of the TOTP and according to the risk index.
Code instructions to output the authentication score to one or more systems adapted to grant the client device access to the secure service according to the authentication score.

The enhanced TOTP may significantly improve robustness and security of TOTP based systems, platforms, services and/or applications since many risk factors may be identified during the authentication process which may be indicative of security threats and/or risks such as, for example, fraudulent access attempts and/or malicious parties impersonating as legitimate users. By analyzing the data collected during the authentication process such risk factors may be detected and quantized to allow the authentication system to evaluate the integrity, genuineness and/or the like of the user and/or of his associated code generation device. This may significantly improve the verification of legitimate users while detecting the fraudulent access attempts. Moreover, as the authentication score may be a scaled value, the access to the secure service granted to the user may be scaled accordingly, i.e. according to the authentication score, for example, ranging from access denial, through limited and/or partial access to full access.

In a further implementation form of the first, second, third and/or fourth aspects, the authentication credentials include one or more members of a group consisting of: a key, a code, an answer to a security question and a biometric verification. Supporting a wide range of authentication credentials may support simple integration and/or adoption of the encoded TOTP in a wide range of applications employing different authentication credentials.

In a further implementation form of the first, second, third and/or fourth aspects, the authentication process is conducted in response to a request from the authentication system to provide the TOTP. Typical TOTP based authentication systems, platforms and schemes employ a handshake in which the user attempting to access the secure service is requested to provide the TOTP. Adapting the encoded TOTP to follow the same sequence and flow may support simple integration and/or adoption of the encoded TOTP in a wide range of applications employing the TOTP authentication.

In a further implementation form of the first, second, third and/or fourth aspects, the authentication process is conducted prior to a request from the authentication system to provide the TOTP. Some existing code generation devices and/or applications may support an operation mode in which the authentication to enable the code generation device is done once and subsequent requests to generate additional TOTP do not require re-enabling the code generation device. In order to comply with such existing code generation devices and/or applications, the code generation device is configured to support this operation mode. However, such operation mode may present a risk in the integrity and/or reliability of the user and may thus be considered a risk factor.

In a further implementation form of the first, second, third and/or fourth aspects, the data collected during the authentication process comprising one or more members of a group consisting of: user information, device information relating to the code generation device, device information relating to the client device, timing information and interaction information relating to interaction of the user with the code generation device. A comprehensive data set encompassing various aspects of the user, the device, the interaction and/or the like may significantly improve identification of potential risk factors in the authentication process and may therefore be indicative that the code generation device may be compromised.

In an optional implementation form of the first, second, third and/or fourth aspects, the encoded TOTP is generated in a machine readable representation. This may simplify the transfer of the encoded TOTP from the code generation device to the client device, in particular in case the code generation device is not integrated with the client device.

In an optional implementation form of the first, second, third and/or fourth aspects, a challenge is received from the authentication system, the challenge comprising data indicative of one or more attributes identified for one or more of: the user, the code generation device and/or the client device. One or more of the attributes are available to the authentication system from one or more previous sessions conducted between the user using a client device and the authentication system. The challenge may be used to enhance the analysis of the collected data as well as serve as a signature for verifying the code generation device as the originator of the encoded TOTP.

In an optional implementation form of the first, second, third and/or fourth aspects, the risk index is calculated according to a comparison between the data collected by the code generation device during the authentication process and the data included in the challenge. Analyzing the collected data compared to the challenge information may significantly improve detection of the risk factors to calculate a more accurate risk index.

In an optional implementation form of the first, second, third and/or fourth aspects, the encoded TOTP is generated based on at least some of the challenge data. [1] In an optional implementation form of the first, second, third and/or fourth aspects, the code generation device is verified by the authentication system as originator of the encoded TOTP according to at least some of the challenge data used by the code generation device to generate the encoded TOTP. Using the challenge as a signature for verifying the code generation device as the originator of the encoded TOTP may significantly increase robustness and/or immunity of the encoded TOTP to potential cyber-attacks initiated by malicious parties impersonating as the code generation device.

In an optional implementation form of the first, second, third and/or fourth aspects, the challenge is received in a machine readable representation. This may simplify the transfer of the challenge from the client device to the code generation device to the client device, in particular in case the code generation device is not integrated with the client device.

In an optional implementation form of the first, second, third and/or fourth aspects, the user is requested to provide additional authentication information to the authentication system in case the risk index exceeds a predefined risk threshold. In case the authenticity, reliability and/or integrity of the user is marginal, requesting the additional authentication information may allow determining whether the user and/or the code generation device are genuine or whether the encoded TOTP originates from an impersonating malicious party.

In an optional implementation form of the first, second, third and/or fourth aspects, the code generation device is integrated in the client device. Some end users may utilize the code generation device as an application executed by the client device associated with the user. While integrating the code generation device in the client device may present some security risks it may be a convenient implementation form as it takes advantage of the already available client device used for accessing the secure service.

In a further implementation form of the first, second, third and/or fourth aspects, the access the client device is granted to the secure service includes granting full access, granting limited access and denying access. Granting the user access to the secure service based on the authentication score may reduce and/or limit the exposure of the secure service to the fraudulent accesses initiated by the malicious party(s) since the access rights granted to the user for accessing the secure service may be limited and/or scalable according to the authentication score.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of generating a TOTP encoded with a risk index calculated to rate an authentication process of a user using a client device to access a secure service, according to some embodiments of the present invention;

FIG. 2A and FIG. 2B are schematic illustrations of exemplary embodiments of a system for generating a TOTP encoded with a risk index calculated to rate an authentication process of a user using a client device to access a secure service, according to some embodiments of the present invention;

FIG. 3 is a flowchart of an exemplary process of authenticating a user using a client device to access a secure service according to a TOTP encoded with a risk index calculated to rate an authentication process of the user, according to some embodiments of the present invention; and

FIG. 4 is a schematic illustration of a sequence for generating a TOTP encoded with a risk index calculated to rate an authentication process of a user using a client device to access a secure service, according to some embodiments of the present invention.

### DESCRIPTION OF SPECIFIC EMBODIMENTS OF THE INVENTION

The present invention, in some embodiments thereof, relates to generating a TOTP for authenticating a user using a client device for accessing a secure service, and, more specifically, but not exclusively, to generating a TOTP encoded with a risk index calculated for an authentication process of a user using a client device for accessing a secure service.

TOTP is used for authenticating a user, specifically authenticating a code generation device associated with the user for granting the user using a client device access to a secure service.

According to some embodiments of the present invention, there are provided methods and systems for generating an enhanced TOTP used for authenticating a user using a client device to access a secure service, a secure system, a secure platform and/or the like (collectively designated secure service herein after) such as, for example, an online finance service (e.g. a banking service, a credit/debit card service, etc.), a remote access system, an entertainment content streaming service and/or the like. The TOTP is enhanced to encode a risk index indicative of a risk level estimated for an authentication process conducted by the user to enable the code generation device. The risk index may be evaluated by an authentication system associated with the secure service (e.g. integrated in, in communication with, etc.) to generate an authentication score which may be used for granting the user full access to the secure service, partial access and/or deny the user access to the secure service.

The user using the client device, for example, a Smartphone, a tablet, a smart watch, a desktop, a laptop, a proprietary client device and/or the like to access the secure service may be requested to provide a TOTP (code). In order to generate the TOTP, the user conducts an authentication process to enable (e.g. launch, initiate, unlock, etc.) a code generation device uniquely associated with the user to generate the TOTP. The code generation device may typically be an independent application specific device or a general purpose device (e.g. a Smartphone, a tablet, a smart watch, a desktop, a laptop, etc.) separated from the client device. The code generation device is operated by the user intermediating between the code generation device and the client device. Optionally, the code generation device communicates with the client device via one or more communication channels. However, the code generation device may be utilized by the client device used by the user, for example, an application, dedicated hardware circuitry and/or a combination thereof.

The authentication process conducted by the user to enable the code generation device requires the user to interact with the code generation device to verify his identity. For example, the user may provide his authentication credentials, for example, a key, a code, a Private Identification Number (PIN), an answer (provided in the past) to a security question and/or the like. In another example, the identity of the user may be verified through one or more biometric verification tests, for example, fingerprint verification, iris recognition, face recognition, voice recognition and/or the like.

During the authentication process conducted by the user to enable the code generation device, the code generation device may collect data relating to the authentication process, for example, user information relating to the user, device information relating to the code generation device and/or to the client device, timing information, interaction information relating to interaction of the user with the code generation device and/or the like. The code generation device may collect the data from one or more sensors, user interfaces, hardware components, software modules and/or the like of the code generation device and/or of the client device.

Based on analysis of the collected data, the code generation device may detect one or more risk factors indicative of a risk that the authentication process may be compromised, i.e. conducted by a person and/or an automated tool impersonating as the user associated with the code generation device. The risk factors may include, for example, a failure of the user to successfully provide his credentials in several attempts, an inconclusive biometric verification, a potential malware (e.g. virus, Trojan horse, etc.) detected in the code generation device and/or the client device, an incompatible hardware and/or software architecture of the code generation device and/or the client device and/or the like.

The code generation device may aggregate the detected risk factor(s) to calculate a risk index indicative of the risk level estimated for the authentication process.

Optionally, the code generation device calculates and/or adjusts the risk index according to challenge information received from the authentication system. The challenge information may include user information, device information, timing information, interaction information and/or the like collected during previous access(s) of the user and/or of the client device to the secure service. The code generation device may compare the data collected during the authentication process against the challenge information to improve detection of the risk factors and enhance estimation of the risk level. For example, based on comparison of the collected data to the challenge information the code generation device may detect additional risk factors, for example, an in compliance of the hardware and/or software architecture of the code generation device and/or the client device compared to those identified in the previous access(s), a deviation of the access time from a timing pattern identified for the previous access(s), a deviation of the geographical location of the code generation device during the access from a geolocation pattern identified for the previous access(s) and/or the like.

The code generation device may generate an encoded TOTP encoding the calculated risk index with a TOTP generated based on a current time (timestamp) and on the unique secret key assigned to the code generation device. In case the challenge was sent to the code generation device, the code generation device may use the challenge and/or part thereof to generate the encoded TOTP. Generating the encoded TOTP based on the challenge information may serve as signature which may be used by the authentication system to verify the encoded TOTP originated from the code generation device which generated the encoded TOTP in response to the (specific) challenge received during a specific authentication process.

The client device may transmit the encoded TOTP generated by the code generation device to the authentication system which may decode the encoded TOTP to extract the risk index. The authentication system may locally generate an encoded TOTP based on the unique secret key assigned to the code generation device retrieved from a database mapping unique secret keys to a plurality of (registered) code generation devices. In order to locally generate the encoded TOTP, the authentication system may generate one or more encoded TOTP codes based on the unique secret key assigned to the code generation device coupled with each of a range of possible risk indices. The authentication system may compare the locally generated encoded TOTP codes with the encoded TOTP received from the code generation device to validate the accessing user and may further verify the encoded TOTP timestamp is valid. In case the challenge was sent to the code generation device and the challenge (or part thereof) is used by the code generation device to generate the encoded TOTP, the authentication system may verify the challenge used to generate the encoded TOTP matches the challenge sent to the code generation device to further verify the encoded TOTP originates from the code generation device.

Based on verification of the unique secret key and according to the extracted risk index, the authentication system may calculate an authentication score for the accessing user attempting to access the secure service. The secure service may grant, deny and/or allow partial (limited) access for the user to the secure service according to the authentication score.

Optionally, specifically in case the risk index is high, for example, exceeding a predefined risk threshold, the authentication system transmits to the client device one or more requests instructing the user to provide additional authentication information. The requested additional authentication information may include, for example, a PIN code, an answer (provided in the past) to a security question, a personal information item (e.g. address, banking account number, credit card number, etc.) and/or the like.

The enhanced TOTP encoding the risk index may present significant advantages over currently existing methods and systems for user authentication, specifically TOTP based authentication systems which may be exposed, subject and/or valuable to a plurality of security threats and risks. For example, a stolen code generation device may be used by a malicious party to impersonate as the legitimate user associated with the code generation device. In another example, malicious software may execute on the code generation device, specifically when implemented by the client device which may monitor interaction of the user with the code generation device to collect generated TOTP codes and potentially compromise the unique secret key(s) assigned to the code generation device. In another example, a malicious party may launch a social-engineering cyber-attack to persuade the user to provide one or more TOTP codes generated by the code generation device. In another example, a malicious party may operate one or more automated tools (e.g. bots) to collect TOTP information from one or more users and apply the TOTP information to attempt accessing the secure service impersonating as the legitimate user(s).

Monitoring the authentication process conducted by the user to generate the encoded TOTP and analyzing the data collected during the authentication process may allow detection of one or more risk factors which may be highly indicative of such security threats and risks. Fraudulent access attempts initiated by the malicious party(s) to access the secure service may be characterized and/or identified by one or more indicators, precursors and/or the like which may be detected and evaluated as risk factors. This may significantly improve the certainty that the user attempting to access the secure service is the legitimate user associated with the code generation device.

Moreover, granting the user(s) access to the secure service based on the authentication score may significantly reduce and/or limit the exposure of the secure service to the fraudulent accesses initiated by the malicious party(s) since the access rights granted to the user for accessing the secure service may be limited and/or scaled according to the authentication score. As such when definite certainty in the user identity is established full access may be granted. However, in case the certainty is less than definite only partial and/or limited access may be granted. Similarly in case the certainty in the user identity is significantly low (e.g. below a predefined threshold) the user may be denies access all together.

Furthermore, using the challenge as a signature to verify the originating device of the encoded TOTP and associate the encoded TOTP with the specific authentication process for which the challenge was sent may significantly improve authentication of the code denegation device as the originator of the encoded TOTP thus further increasing reliability in the authentication process conducted by the user. This may also increase robustness and/or immunity of the encoded TOTP authentication against malicious parties who may eavesdrop on the communication between the code generation device and the authentication system in attempt to impersonate as the code generation device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer Program code comprising computer readable program instructions embodied on a computer readable medium may be transmitted using any appropriate medium, including but not limited to wireless, wire line, optical fiber cable, RF, etc., or any suitable combination of the foregoing.

The program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code can be downloaded to respective computing/processing devices from a computer readable storage medium or to an external computer or external storage device via a network, for example, the Internet, a local area network, a wide area network and/or a wireless network.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention.

In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

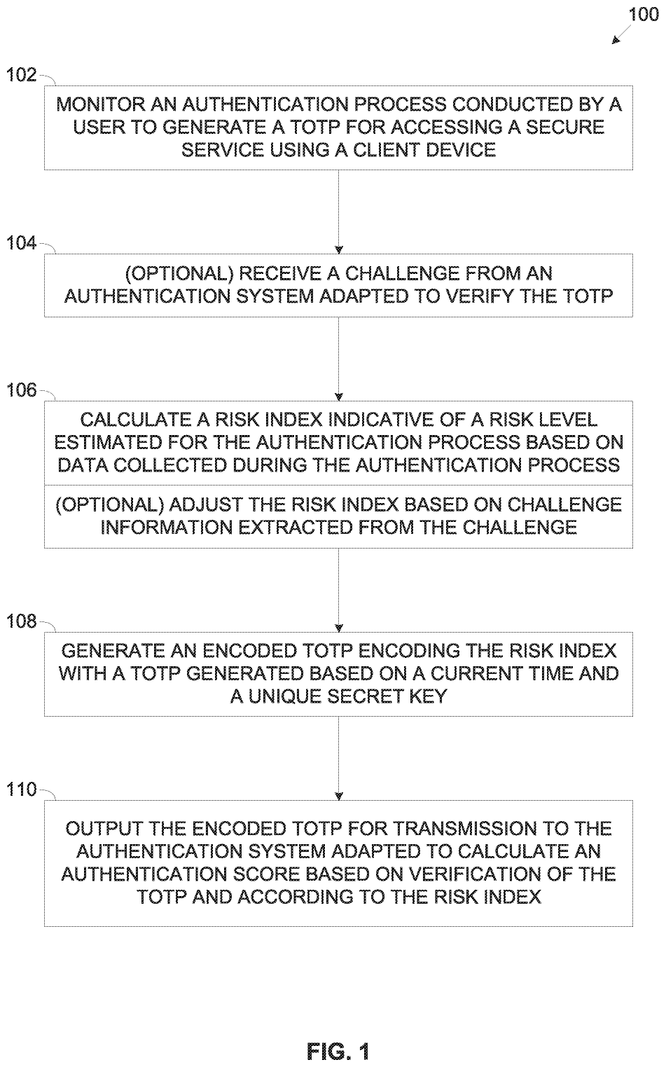

Reference is now made to FIG. 1, which is a flowchart of an exemplary process of generating a TOTP encoded with a risk index calculated to rate an authentication process of a user using a client device to access a secure service, according to some embodiments of the present invention. An exemplary process 100 may be executed by a code generation device for calculating a risk index for a user using a client device accessing a secure service requiring TOTP authentication of the user before granting access. The user may conduct an authentication process with the code generation device to authenticate his identify in order to enable the code generation device to generate the TOTP. The authentication process is monitored by the code generation device to evaluate its risk level in order to estimate integrity, genuineness and/or reliability of the authentication process and hence of the user attempting to access the secure service a secure system, a secure platform and/or the like collectively referred to as the secure service herein after.

The code generation device may calculate the risk index according to data collected during the authentication process in which the user interacts with the code generation device to generate the TOTP to be transmitted via the client device for accessing the secure service. The collected data may include, for example, user information relating to the user, device information relating to the code generation device and/or to the client device, timing information, and interaction information relating to interaction of the user with the code generation device and/or the like.

The calculated risk index calculated based on the data collected during the authentication process and which may be indicative of a risk level estimated for an authentication process the user conducts using his client device to enable generation of the TOTP. The data may be collected from one or more sensors, user interfaces, hardware components and/or software modules of the code generation device and/or of the client device.

Optionally, the code generation device may calculate and/or adjust the calculated risk index according to challenge information received from an authentication system associated with the secure service. The challenge information may include user information, device information, timing information, interaction information and/or the like collected during previous access(s) of the user and/or of the client device to the secure service. The data collected during the authentication process may be compared against the challenge information to improve estimation of the risk level.

The code generation device may generate the TOTP based on a current time (timestamp) and on a unique secret key assigned to the code generation device and may further encode the TOTP with the risk index to produce an encoded TOTP transmitted to the authentication system. Based on verification of the unique secret key and according to the estimated risk index, the authentication system may grant the user access to the secure service, deny access, grant partial access and/or the like.

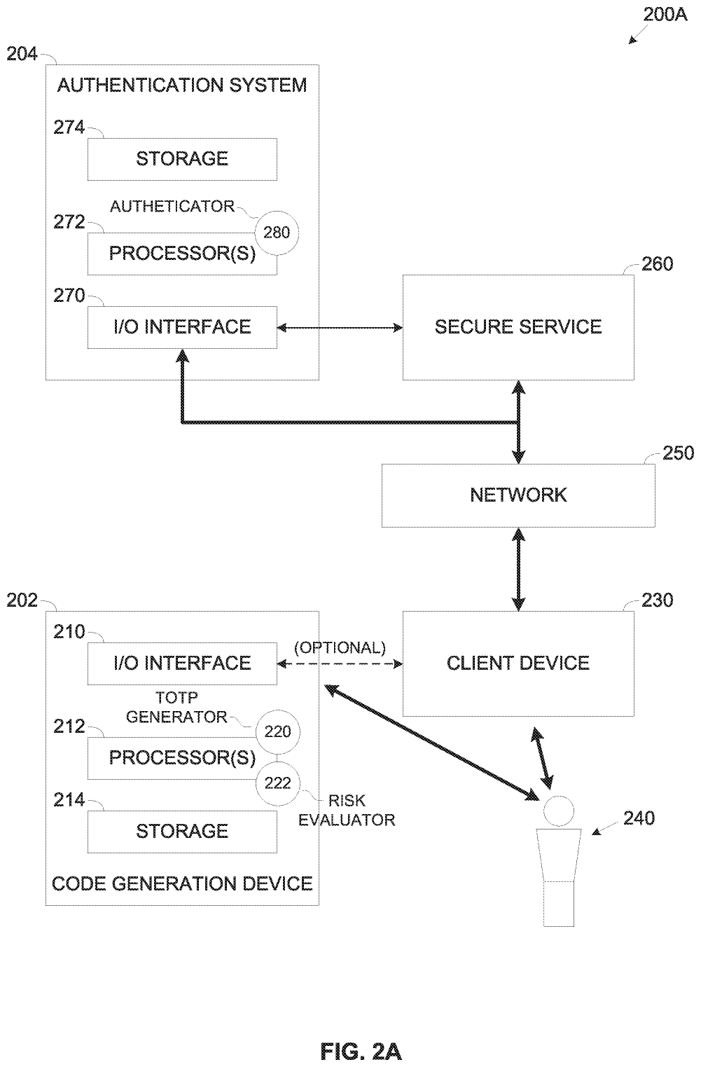

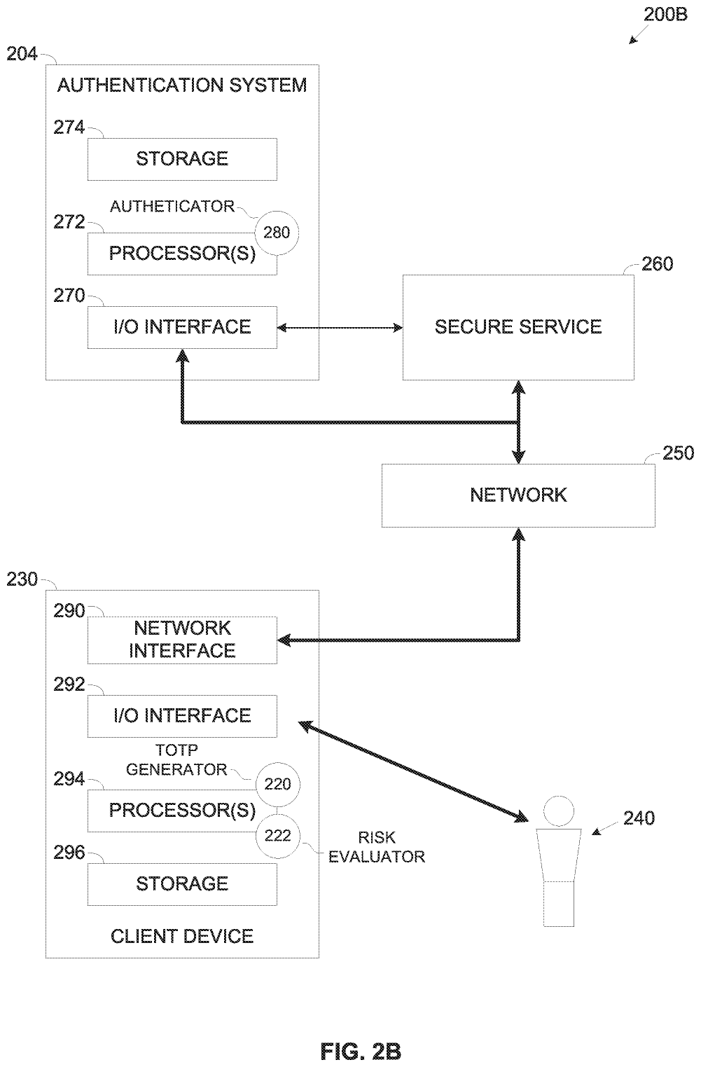

Reference is also made to FIG. 2A and FIG. 2B, which are schematic illustration of exemplary embodiments of a system for generating a TOTP encoded with a risk index calculated to rate an authentication process of a user using a client device to access a secure service, according to some embodiments of the present invention.

An exemplary system 200A may include a code generation device 202 used by a user 240 in conjunction with a client device 230, for example, a Smartphone, a tablet, a smart watch, a desktop, a laptop, a proprietary client device and/or the like to access a secure service 260 associated with an authentication system 204 for TOTP authentication to allow access the secure service 260. As shown, the code generation device 202 may be a device such as, for example, a Smartphone, a tablet, a smart watch, a desktop, a laptop, a proprietary client device and/or the like which is independent of the client device 230. As such, the code generation device 202 is operated by the user 240 intermediating between the code generation device 202 and the client device 230.

The client device 230 used by the user 240 to access the secure service 260 may communicate with the secure service 260 via a network 250 comprising one or more wired and/or wireless networks, for example, a Local Area Network (LAN), a Wide Area Network (WAN), a Metropolitan Area Network (MAN), a cellular network, the internet and/or the like.

The secure service 260 may include, for example, a secure service, a secure system, a secure platform and/or the like to which the user 240 may be granted remote access, for example, an online finance service (e.g. a banking service, a credit/debit card service, etc.), a remote access system, an entertainment content streaming service and/or the like. The secure service 260 may be utilized by, for example, a server, a computing node, a cluster of computing nodes, a cloud service, cloud platform, cloud application and/or the like connected to the network 250.

The code generation device 202 associated with the user 240 for generating the TOTP(s) may comprise an Input/Output (I/O) interface 210 for interacting with the user 240 and optionally with the client device 230, a processor(s) 212 for executing a process such as the process 100 and a storage 214 for storing data and/or code (program store).

The I/O interface 210 may include one or more user interfaces for interacting with the user 240, for example, a keyboard, a pointing device, a touchscreen, a display, a speaker, an earphone, a microphone and/or the like for interacting with the user 240. The I/O interface 210 may optionally include one or more biometric sensors and/or devices, for example, a tactile senor (for fingerprint verification), an imaging sensor (for iris and/or face recognition, etc.), microphone (for voice recognition) and/or the like. The I/O interface 210 may also include one or more imaging sensors, for example, a camera, a scanner and/or the like for scanning one or more machine readable representations, for example, a barcode, a QR code and/or the like.

Optionally, the I/O interface 210 includes one or more wired and/or wireless interfaces for communicating with the client device 230, for example, a Universal Serial Bus (USB), a serial interface, a Radio Frequency (RF) interface, a Near Field Communication (NFC) interface, a Wireless LAN (WLAN, e.g. Wi-Fi, etc.) interface and/or the like for communicating with the client device 230.

The processor(s) 212, homogenous or heterogeneous, may include one or more processing nodes arranged for parallel processing, as clusters and/or as one or more multi core processor(s). The storage 214 may include one or more non-transitory persistent storage devices, for example, a Read Only Memory (ROM), a Flash array, a hard drive and/or the like. The storage 214 may also include one or more volatile devices, for example, a Random Access Memory (RAM) component and/or the like.

The processor(s) 212 may execute one or more software modules such as, for example, a process, a script, an application, an agent, a utility, a tool and/or the like each comprising a plurality of program instructions stored in a non-transitory medium (program store) such as the storage 214 and executed by one or more processors such as the processor(s) 212. For example, the processor(s) 212 may execute a TOTP generator 220 software module for generating a TOTP based on a unique secret key assigned to the code generation device 202 and a risk evaluator 222 software module to evaluate a risk level of the authentication process conducted by the user 240 using the client device 230 to access the secure service 260. The TOTP generator 220 and/or the risk evaluator 222 may further utilize one or more hardware elements, for example, a circuit, a component, an Integrated Circuit (IC), an Application Specific Integrated Circuit (ASIC), a Field Programmable Gate Array (FPGA), a Digital Signals Processor (DSP) and/or the like.

An exemplary system 200B presents another exemplary embodiment of the present invention in which the code generation device 202 is utilized by the client device 230 such that the TOTP generator 220 and the risk evaluator 222 are executed by the client device 230. The TOTP generator 220 and the risk evaluator 222 may be utilized, for example, by one or more applications, one or more dedicated hardware circuitries and/or a combination thereof. This embodiment may present some vulnerability to cyber-attacks compared to the exemplary system 200A due to the connectivity of the client device 230 to the network 250, however by applying some security measures such risks may be mitigated.

The client device 230 may include a network interface 290 comprising one or more wired and/or wireless communication interfaces for connecting to the network 250, an I/O interface 292 such as the I/O interface 210 for interacting with the user 240, a processor(s) 294 such as the processor(s) 212 for executing the TOTP generator 220 and the risk evaluator 222 and storage 296 such as the storage 214.

The authentication system 204 associated with the secure service 260 may be adapted to authenticate the TOTP received from the client device 230 attempting to access the secure service 260. The authentication system 204 may comprise an I/O interface 270 to connect to the network 250, a processor(s) 272 such as the processor(s) 212 for executing a process to authenticate the TOTP received from the client device 230 and storage 274 such as the storage 214. The I/O interface 270 may further include one or more wired and/or wireless network interfaces for connecting to the network 250 to communicate with the secure service 260 and/or one or more client devices 230. The storage 274 may further comprise one or more network storage devices, for example, a storage server, a Network Accessible Storage (NAS), a network drive and/or the like accessible through the I/O interface 270.

The processor(s) 272 may execute one or more software modules each comprising a plurality of program instructions stored in a non-transitory medium (program store) such as the storage 274 and executed by one or more processors such as the processor(s) 272. For example, the processor(s) 212 may execute an authenticator 280 software module for authenticating the user 240 using the client device 230 to access the secure service 260. The authenticator 280 may further utilize one or more hardware elements may include, for example, a circuit, a component, an IC, an ASIC, an FPGA, a DSP and/or the like.

Optionally, the authentication system 204 and/or the authenticator 280 executed by the authentication system 204 are implemented as one or more cloud computing services, for example, an Infrastructure as a Service (IaaS), a Platform as a Service (PaaS), a Software as a Service (SaaS) and/or the like such as, for example, Amazon Web Service (AWS), Google Cloud, Microsoft Azure and/or the like.

Optionally, the authentication system 204 is integrated with the secure service 260 such that the secure service 260 executes the authenticator 280.

The exemplary process 100 and the exemplary systems 200A and 200B describe a single client device 230 used by a single user 240 to access the secure service 260. This however should not be construed as limiting since the process 100 and the systems 200A and/or 200B may be applied to serve a plurality of client device 230 used by a plurality of user 240 to access the secure service 260.

As shown at 102, the process 100 executed by the code generation device 202 starts with the risk evaluator 222 monitoring an authentication process in which the user 240 interacts with the code generation device 202, specifically to enable the code generator 220, for example, initiate, unlock and/or launch for generating a TOTP to be used by the client device 230 for accessing the secure service 260.

The authentication process may typically be initiated after the user 240 attempts to access the secure service 260 and is requested by the authentication system 204, specifically by the authenticator 280 to provide the TOTP. However, it is possible that the user 240 conducted the authentication process with the code generator 220 prior to the request to provide the TOTP. In such case the code generator 220 may already be enabled for generating the TOTP to be used by the client device 230 for accessing the secure service 260.

During the authentication process the user 240 may interact with the code generator 220 via the I/O interface 210 to enable the code generator 220. As the code generator 220 may typically be a secure application requiring the user 240 to verify his identity, i.e. to authenticate himself, the user 240 may engage in an authentication process with the code generator 220 to provide his unique authentication credentials to enable the code generator 220.

The authentication credentials may include, for example, a key, a code, a PIN, an answer (provided in the past) to a security question and/or the like. The code generator 220 may compare the authentication credentials against authentication credentials previously (in the past) provided by the user 240 and stored in the code generation device 202 (embodiment 200A) and/or the client device 230 (embodiment 200B), for example, in the storage 214 and/or the storage 294 respectively.

Additionally and/or alternatively, the code generator 220 may verify the identity of the user 240 through one or more biometric verifications. For example, the code generator 220 may analyze a fingerprint pattern of the user 240 captured by the tactile sensor and compare it against a reference fingerprint pattern previously provided by the user 240 and stored in the code generation device 202 (embodiment 200A) and/or the client device 230 (embodiment 200B). In another example, the code generator 220 may analyze an iris pattern and/or a face pattern of the user 240 captured by the imaging sensor and compare them against reference iris and/or face patterns previously provided by the user 240 and stored in the code generation device 202 (embodiment 200A) and/or the client device 230 (embodiment 200B). In another example, the code generator 220 may analyze a voice of the user 240 captured by the microphone and compare it against a reference voice pattern previously provided by the user 240 and stored in the code generation device 202 (embodiment 200A) and/or the client device 230 (embodiment 200B).

The risk evaluator 222 may monitor the authentication process by collecting data, during the authentication process, from one or more sensors, user interfaces, hardware components and/or software modules of the code generation device 202 to detect one or more attributes of the authentication process. The authentication process attribute(s) describing the authentication process may be indicative of genuineness, reliability and/or authenticity of the user 240.

For example, the risk evaluator 222 may monitor one or more of the user interfaces and/or biometric sensors provided by the I/O interface 210 to detect one or more attributes of the authentication process, specifically attributes of the interaction of the user 240 with the code generation device 202 and/or with the client device 230. For example, monitoring the user interfaces, the risk evaluator 222 may detect that the user 240 failed to enter his authentication credentials (e.g. key, PIN, etc.) in two consecutive attempts before succeeding to type his correct PIN code on the 3rd attempt. In another example, the risk evaluator 222 may monitor one or more of the biometric sensors to detect to detect a correct, partial (inconclusive) and/or failed biometric verification of the user 240.

In another example, the risk evaluator 222 may collect data from one or more hardware components of the code generation device 202 to detect one or more attributes of the authentication process. For example, the risk evaluator 222 may collect data from a clock circuit to obtain a current timing, for example, a time, a date, day of week and/or the like. In another example, the risk evaluator 222 may collect geolocation data from a geolocation sensor, for example, a Global Positioning System (GPS) sensor and/or the like. Naturally, the risk evaluator 222 may collect the data by communicating with one or more software modules operating the hardware component(s) rather than directly accessing the hardware component(s).

In another example, the risk evaluator 222 may communicate with one or more software modules executed by the code generation device 202 and/or by the client device 230 to detect one or more attributes of the authentication process. For example, the risk evaluator 222 may communicate with the code generator 220 to determine whether the user 240 was properly authenticated, for example, has the user 240 successfully provided his authentication credentials, has the user 240 failed in one or more attempts to provide his authentication credentials, was the user 240 properly verified by the biometric verification and/or the like.

In another example, the risk evaluator 222 may communicate with one or more software modules executed by the code generation device 202 and/or by the client device 230 to collect device information of the hardware and/or software configuration of the code generation device 202. For example, the risk evaluator 222 may communicate with one or more services of an Operating System (OS) executed by the code generation device 202 and/or by the client device 230 to identify the software configuration, for example, installed software module(s), genuineness of installed software module(s), version of software module(s), latest use of software module(s), latest update of software module(s) and/or the like. In another example, the risk evaluator 222 may communicate with a cyber security software module to identify a security status of the code generation device 202 and/or of the client device 230, for example, a presence of malware, a last time of system security scan, a history of detected cyber threats and/or the like. In another example, the risk evaluator 222 may communicate with a device manager software module to identify the hardware configuration, for example, a processor type, a platform (chipset) type, available communication interface(s), available user interface(s) and/or the like. In another example, the risk evaluator 222 may communicate with the code generator 220 to determine whether the code generator 220 was already enabled (e.g. unlocked) at the time the request to provide the TOTP was received from the authenticator 280, i.e. whether the code generator 220 was enabled prior to the TOTP request.

As shown at 104, which is an optional step, the risk evaluator 222 may receive a challenge from the authentication system 204, specifically from the authenticator 280. This step is not mandatory and may be applied to enhance the evaluation of the authentication process.

The challenge transmitted from the authenticator 280 may be received by the client device 230. Since typically the code generation device 202 is independent from the client device 230 (embodiment 200A), the received challenge needs to be provided to the code generation device 202, specifically to the risk evaluator 222.

The user 240 operating as a mediator between the code generation device 202 and the client device 230 may provide the challenge received at the client device to the code generation device 202. For example, the user 240 may operate one or more of the user interfaces of the I/O interface 210 (e.g. keyboard, touchscreen, etc.) to insert the challenge. In order to simplify the manual process of inserting the received challenge to the code generation device 202, the authenticator 280 may construct and transmit the challenge in one or more machine readable representations, for example, a barcode, a QR code and/or the like. The machine readable representation(s) may be presented by one or more of the user interfaces provided by the I/O interface 292 of the client device 230, for example, a display, a touchscreen and/or the like. The risk evaluator 222 may operate one or more interfaces provided by the I/O interface 210, for example, the camera, the scanner and/or the like to scan the machine readable representation(s) of the challenge presented by the client device 230.

Optionally, via the I/O interface 210, the code generation device 202 may communicate with the client device 230 to obtain the challenge received from the authenticator 280 by the client device 230.

The authenticator 280 may generate the challenge based on an external challenge derived from the transaction the user 240 attempts to initiate with the secure service 260 coupled with challenge information relating to the user 240 and/or to the client device 230 collected during one or more previous accesses of the user 240 to the secure service 260.

The challenge information may include, for example, the software configuration and/or the hardware configuration of the client device 230 as identified during previous access(s) of the user 240 using the client device 230 to the secure service 260. In another example, the challenge information may include the software configuration and/or the hardware configuration of the code generation device 202 as identified during the previous access(s). In another example, the challenge information may include timing information relating to the previous access(s), for example, typical access time(s), a distribution of access times over the day and/or over the week and/or the like. In another example, the challenge information may include geolocation information relating to the geographical location(s) and/or geolocation distribution of the client device 230 during the previous access(s).

As shown at 106, the risk evaluator 222 analyzes the authentication process attribute(s) to determine whether the authentication process presents one or more risk factors and calculate a risk index for the authentication process based on the identified risk factor(s).

For example, assuming the risk evaluator 222 evaluates, based on the collected data, that a malware may be present in the code generation device 202 and/or in the client device 230. This may be indicative that the code generation device 202 and/or the client device 230 may be compromised and the risk evaluator 222 may therefore determine this as a risk factor.

In another example, the risk evaluator 222 may identify one or more risk factors in case the user 240 failed to properly provide his authentication credentials during the authentication process to enable the code generator 220. For example, assuming the code generator 220 was enabled only in a 2nd or 3rd attempt, this may be indicative that the operator (human or automated tool) is not familiar with the authentication credentials of the user 240 associated with the client device 230 and/or with the code generating device 202 and may thus not be the associated user 240 and the risk evaluator 222 may therefore determine this as a risk factor.

In another example, assuming the user 240 was not conclusively verified by the biometric verification, this may be indicative that the user operating the code generation device 202 may not be the associated user 240 and the risk evaluator 222 may therefore determine this as a risk factor. In another example, assuming the risk evaluator 222 fails to obtain geolocation information from the geolocation sensor during the authentication process, this may be indicative that the code generation device 202 and/or the client device 230 may be compromised and the risk evaluator 222 may therefore determine this as a risk factor.

In another example, assuming the code generator 220 was enabled prior to receiving from the authenticator 280 the request to provide the TOTP, the risk evaluator 222 may determine this as a risk factor since it presents a potential risk that the TOTP was generated while the code generation device 202 was not in possession of the associated user 240. For example, the associated user 240 may have left the code generation device 202 unattended and someone might have operated the enabled (e.g. unlocked) code generator 220 to generate the TOTP.

Optionally, in case the challenge was received from the authenticator 280, the risk evaluator 222 extracts the challenge information from the received challenge and adjusts the risk index according to a comparison of the data collected during the authentication process with the challenge information.

For example, assuming that the geolocation of the client device 230 during the authentication process significantly deviates from the geolocation information extracted from the challenge information, this may be indicative that the code generation device 202 is not in possession of the associated user 240 and the risk evaluator 222 may therefore determine this as a risk factor.

In another example, assuming that the timing of the authentication process significantly deviates from the timing information extracted from the challenge information, this may also be indicative that the code generation device 202 is not in possession of the associated user 240 and the risk evaluator 222 may therefore determine this as a risk factor.

In another example, assuming that the software configuration and/or hardware configuration identified for the code generation device 202 and/or for the client device 230 during the authentication process is significantly different than the software configuration and/or hardware configuration extracted from the challenge information. This may be indicative of the code generation device 202 and/or for the client device 230 being compromised and the risk evaluator 222 may therefore determine this as a risk factor.

Based on the identified risk factors, the risk evaluator 222 may calculate a risk index for the authentication process. For example, each of the risk factors may be assigned with a predefined priority and numerical identifier (ID) with a special numeric ID for “no risk” indication. The risk evaluator 222 may set the risk index to equal the ID of the highest priority identified risk factor. In another example, the risk evaluator 222 may aggregate the IDs of all identified risk factor(s) to produce the risk index. In another example, the risk index may comprise a predefined bitmask in which each of the risk factors is mapped to a respective bit. The risk evaluator 222 may set each of the bits in the bitmask according to the identified risk factor, for example, set the bit to “0” in case the respective mapped risk factor is not detected and set the bit to “1” in case the respective mapped risk factor is detected.

As shown at 108, after the user 240 is properly verified, i.e. the authentication credentials are verified, the biometric verification is done and/or the like, the code generation device 202 may generate an encoded TOTP which encodes the risk index with a TOTP generated by the code generator 220.

The code generator 220 generates the TOTP based on a current time and on the unique secret key assigned to the code generation device 202. As such the TOTP is uniquely associated with the code generation device 202 and is valid for a limited predefined time period which may be determined based on the generation time of the TOTP.

Optionally, in case the challenge was received from the authentication system 204, the code generator 220 may further use the challenge and/or part thereof together with the unique secret key and the current time to generate the encoded TOTP. Using the challenge information for generating the encoded TOTP may significantly increase robustness and integrity of the encoded TOTP since the authenticator 280 may validate that the encoded TOTP originates from the specific code generation device 202 to which the specific challenge was sent.

For example, the code generator 220 may generate the TOTP by applying the HOTP calculation function defined by the RFC4226 HOTP. For example, for a given unique secret key K, at a given time TC the code generator 220 may generate the TOTP using the calculation function HOTP(K, TC). Moreover, in case a given challenge C was received from the authenticator 280, TC may be concatenated with the challenge C. In such case the code generator 220 may generate the TOTP using the calculation function HOTP(K, TC∥C).

The code generation device 202 may apply one or more of a plurality of encoding implementations, methods, algorithms and/or the like for encoding the risk index with the TOTP. The following examples are provided for a case where the challenge is received from the authenticator 280. However the same methods and/or calculations may be apply with the challenge discarded in case no challenge is received from the authenticator 280.

In a first TOTP encoding scheme example, a set of unique secret keys [K₁, . . . , Kn] may be provisioned to the code generation device 202 rather than a single unique secret key. The code generation device 202 may encode the risk index with the TOTP by operating the code generator 220 to generate the TOTP based on one of the unique secret keys selected from the set according to the calculated risk index and a concatenation of the current time and the challenge. For example, at a given time TC with a given challenge C, the code generator 220 may be operated to generate the TOTP using the calculation function HOTP(Kᵢ, TC∥C) where Kᵢ is the i^{th} unique secret keys selected by the code generation device 202 from the set and i is the value of the risk index. To further illustrate this example, assuming at time TC the risk evaluator 222 identifies two risk factors, assigned IDs 0 and 2. Assuming the bitmap implementation is used, the risk index is 2°+2²=5, and the code generator 220 may generate the TOTP according to HOTP(K₅, TC∥C), i.e. the code generation device 202 operates the code generator 220 to generate the TOTP using the fifth unique secret key from the set.

In a second TOTP encoding scheme example, the code generation device 202 may concatenate the risk index to the challenge and operate the code generator 220 to generate the TOTP based on the unique secret key and a concatenation of the current time, the challenge and the risk index. For example, at a given time TC with a given challenge C, the code generator 220 may be operated to generate the TOTP using the calculation function HOTP(K, TC∥C∥R) where R is the value of the risk index. To further illustrate this example, assuming at time TC the risk evaluator 222 identifies two risk factors, assigned IDs 1 and 2. Assuming the bitmap implementation is used the risk index is 2¹+2²=6, and the code generator 220 may generate the TOTP according to HOTP(K, TC∥C∥6).

In a third TOTP encoding scheme example, the code generation device 202 may further augment the TOTP generated according to the first TOTP encoding scheme by including the risk index to create the encoded TOTP. Continuing the example presented in the first TOTP encoding scheme, the code generation device 202 may concatenate the risk level i with the TOTP generated by the code generator 220 to produce the encoded TOTP according to HOTP(Kᵢ, TC∥C)∥i.

In a fourth TOTP encoding scheme example, the code generation device 202 may further augment the TOTP generated according to the second TOTP encoding scheme by including the risk index to create the encoded TOTP. Continuing the example presented in the second TOTP encoding scheme, the code generation device 202 may concatenate the risk level R with the TOTP generated by the code generator 220 to produce the encoded TOTP according to HOTP(K, TC∥C∥R)∥R.

As shown at 110, the code generation device 202 may output the encoded TOTP which may be transmitted by the client device 230 to authenticate the user 240 at the authentication system 204, specifically to the authenticator 280 for granting the user 240 access to the secure service 260.

Typically since the code generation device 202 is independent from the client device 230 (embodiment 200A) the encoded TOTP is provided to the client device 230 by the user 240 intermediating between the code generation device 202 and the client device 230. For example, the user 240 may operate one or more of the user interfaces of the I/O interface 292 (e.g. keyboard, touchscreen, etc.) of the client device 230 to insert the encoded TOTP generated by the code generation device 202. In order to simplify the manual process conducted by the user 240 to provide the encoded TOTP to the client device 230, the code generation device 202 may construct the encoded TOTP in one or more machine readable representations, for example, a barcode, a QR code and/or the like. The machine readable representation(s) may be presented by one or more of the user interfaces provided by the I/O interface 210 of the code generation device 202, for example, the display, the touchscreen and/or the like. Using one or more interfaces provided by the I/O interface 292, for example, a camera, a scanner and/or the like, the client device 230 may obtain the encoded TOTP by scanning its machine readable representation(s) presented by the code generation device 202.

Optionally, using the I/O interface 210, the code generation device 202 may communicate with the client device 230 via one or more communication channels to output the encoded TOTP to the client device 230.

Optionally, in case the code generation device 202 is integrated with the client device 230 communicating with the authentication system 204 (embodiment 200B), the encoded TOTP may be directly transmitted to the authenticator 280 via the network interface 290.

Optionally, the authenticator 280 transmits to the client device 230 one or more requests instructing the user 240 to provide additional authentication information. The authenticator 280 may issue such requests, for example, in case the authenticator 280 determines, based on comparison of the encoded TOTP locally generated by the authenticator 280 with the encoded TOTP received from the code generation device 202, that the risk level identified for the authentication process is significant, for example, exceeding a certain risk threshold. The requested additional authentication information may include, for example, a PIN code, an answer (provided in the past) to a security question, a personal information item (e.g. address, banking account number, credit card number, etc.) and/or the like.

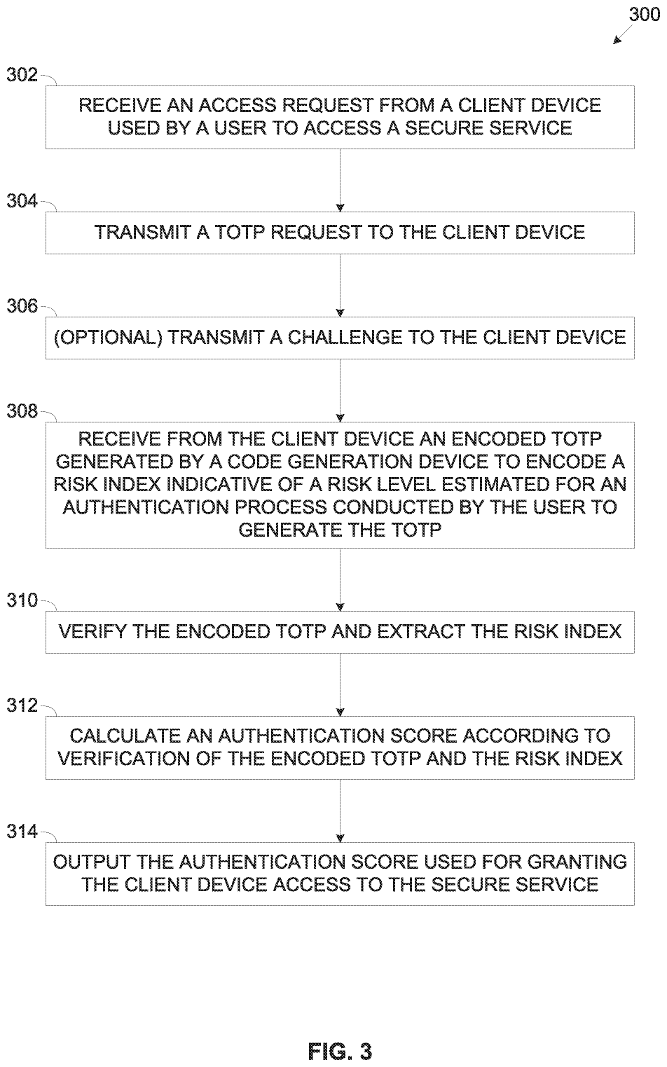

Reference is now made to FIG. 3, which is a flowchart of an exemplary process of authenticating a user using a client device to access a secure service according to a TOTP encoded with a risk index calculated to rate an authentication process of the user, according to some embodiments of the present invention. An exemplary process 300 may be executed by an authentication system such as the authentication system 204, in particular by an authenticator such as the authenticator 280. The process 300 is a complementary process to the process 100 executed by a code generation device such as the code generation device 202. The authenticator 280 may execute the process 300 to calculate an authentication score for a user such as the user 240 using a client device such as the client device 230 attempting to access a secure service such as the secure service 260. The authenticator 280 may calculate the authentication score based on verification of the code generation device 202 according to the encoded TOTP and according to the risk index extracted from the encoded TOTP generated by the risk evaluator 222 executing the process 100.

Similarly to the process 100, the process 300 is described for a single client device 230 used by a single user 240 to access the secure service 260. This however should not be construed as limiting since the process 300 may be applied to serve a plurality of client device 230 used by a plurality of user 240 to access the secure service 260.

As shown at 302, the process 300 starts with the authenticator 280 receiving an access request from the client device 230 used by the user 240 to access the secure service 260.

As shown at 304, the authenticator 280 transmits to the client device 230 a request to provide a TOTP, in particular an encoded TOTP encoding the risk index calculated by the risk evaluator 222 for an authentication process conducted by the user 240 to enable the code generation device 202 for generating the TOTP.

As shown at 306, which is an optional step, the authenticator 280 may transmit a challenge for use by the code generation device 202, specifically for use by the risk evaluator 222. The authenticator 280 may transmit the challenge to the client device 230 operated by the user 240 to transfer the challenge to the code generation device 202. As described in step 104 of the process 100, this step is optional and may be applied to enhance the evaluation of the authentication process. The challenge comprising challenge information may be generated by the authenticator 280 as described in step 104 of the process 100.

As shown at 308, the authenticator 280 receives from the code generation device 202 the encoded TOTP generated as described in steps 104 and 106 of the process 100.

As shown at 310, the authenticator 280 verifies the encoded TOTP and extracts the risk index calculated by the risk evaluator 222 for the authentication process conducted by the user 240. The authenticator 280 may locally generate an encoded

TOTP based on the unique secret key assigned to the code generation device 202 which may be retrieved from one or more authentication keys datasets associating a plurality of code generation devices with their assigned unique secret key(s). Since the encoded TOTP encodes the risk index calculated by the risk evaluator 222, the authenticator 280 may generate multiple encoded TOTP codes each generated based on the unique secret key assigned to the code generation device 202 and a certain value of the range of possible risk indices. The authenticator 280 may further generate one or more encoded TOTP codes based on the unique secret key assigned to the code generation device 202, the risk index(s) and one or more time values within the predefined valid time period to verify the time frame of generation of the encoded TOTP is valid.

The authenticator 280 may verify the encoded TOTP received from the code generation device to authenticate the code generation device 202 by comparing the locally generated encoded TOTP code(s) with the received encoded TOTP 202. In case of a match the encoded TOTP is verified and hence the code generation device 202 is verified.

In case the authenticator 280 sent the challenge and the challenge is used by the code generation device 202 to generate the encoded TOTP, the authenticator 280 may associate the encoded TOTP with the sent challenge. As such the challenge information may serve as a signature which may be used by the authenticator 280 to verify that the encoded TOTP is sent from the (specific) code generation device 202 in response to the (specific) challenge originally generated by the authenticator 280 for the (specific) code generation device 202. This may further allow the authenticator 280 to associate the encoded TOTP with the specific authentication process for which the challenge was sent to the code generation device 202.

The authenticator 280 may access to the authentication keys dataset, for example, a list, a table, a database and/or the like associating each of a plurality of code generation devices such as the code generation device 202 with one or more unique secret keys assigned to the respective code generation device 202. The authentication keys dataset may be locally stored in the authentication system 204, for example, in storage such as the storage 274. Optionally, the authentication keys dataset is located in a remote networked resource accessible to the authenticator 280 via a network such as the network 250.

The authenticator 280 may decode the encoded TOTP by applying the same encoding calculation as done by code generation device 202 to generate an encoded TOTP using the unique secret key assigned to the specific code generation device 202 which is retrieved from the authentication keys dataset. The authenticator 280 may then compare the encoded TOTP it generated with the encoded TOTP received from code generation device 202 and check for a match. As described before in step 108 of the process 100, the following examples are provided for a case where the challenge is transmitted to the code generation device 202 and used for evaluating the risk factors and calculating the risk index. However the same methods and/or calculations may be applied with the challenge discarded in case no challenge is transmitted and used by the risk evaluator 222.

As the code generation device 202 may apply one or more TOTP encoding schemes, implementations, methods, algorithms and/or the like for generating the encoded TOTP, the authenticator 280 may apply one or more complementary decoding implementations, methods, algorithms to decode the encoded TOTP.

Continuing the first TOTP encoding scheme example, in which the code generation device 202 may be assigned a set of unique secret keys rather than a single unique secret key. The authenticator 280 may retrieve the set of unique secret keys assigned to the code generation device 202 from the authentication keys dataset. The authenticator 280 may generate a plurality of encoded TOTPs with all possible risk index values and all the unique secret keys in the set. The authenticator 280 may compare each of the plurality of generated encoded TOTPs to the encoded TOTP received from code generation device 202 and check for a match. In case a match is detected (the unique secret code is verified), the authenticator 280 may verify the unique secret key assigned to the code generation device 202 and may thus obtain the risk index encoded with the TOTP. For example, the authenticator 280 may apply an exemplary procedure described in pseudo code excerpt 1 below.

Pseudo Code Excerpt 1:

```
given ic = input code,
for i <- 0 .. maximum risk index,
  if HOTP(Kᵢ, TC || C) == ic,
    report successful validation with risk index i
report unsuccessful validation
```

Continuing the second TOTP encoding scheme example, in which the risk index is concatenated with the current time and the challenge. The authenticator 280 may retrieve the unique secret key assigned to the code generation device 202 from the authentication keys dataset. The authenticator 280 may generate a plurality of encoded TOTPs with all possible risk index values and the unique secret key assigned to the code generation device 202. The authenticator 280 may compare each of the plurality of generated encoded TOTPs to the encoded TOTP received from code generation device 202 and check for a match. In case a match is detected (the unique secret code is verified), the authenticator 280 may verify the unique secret key assigned to the code generation device 202 and may thus obtain the risk index encoded with the TOTP. For example, the authenticator 280 may apply an exemplary procedure described in pseudo code excerpt 2 below.

Pseudo Code Excerpt 2:

```
given ic = input code,
for i <- 0 .. maximum risk index,
  if HOTP(K, TC || C || i) == ic,
    report successful validation with risk index i
report unsuccessful validation
```

Continuing the third TOTP encoding scheme example in which the encoded TOTP generated using the first TOTP encoding scheme is further augmented to include the risk index to the encoded TOTP. The risk index may be directly extracted from augmented encoded TOTP thus avoiding the need to enumerate different unique secret keys of the set or concatenated challenges. For example, the authenticator 280 may apply an exemplary procedure described in pseudo code excerpt 3 below.

Pseudo Code Excerpt 3:

```
given ic = input code,
let i:=last digit of input code
if HOTP(Kᵢ, TC || C) == ic,
  report successful validation with risk index i
otherwise,
  report unsuccessful validation
```

Continuing the fourth TOTP encoding scheme example in which the encoded TOTP generated using the second TOTP encoding scheme is further augmented to include the risk index to the encoded TOTP. As described for the third TOTP encoding scheme, the risk index may be directly extracted from augmented encoded TOTP thus avoiding the need to enumerate different unique secret keys of the set or concatenated challenges. For example, the authenticator 280 may apply an exemplary procedure described in pseudo code excerpt 4 below.

Pseudo Code Excerpt 4:

```
given ic = input code,
let i:=last digit of input code
if HOTP(K, TC || C || i) == ic,
  report successful validation with risk index i
otherwise,
  report unsuccessful validation
```

Regardless of which TOTP encoding scheme is selected and used, the authenticator 280 may verify the timestamp TC by locally generating a plurality of encoded TOTP codes based on the unique secret key assigned to the code generation device 202, the risk index(s) and one or more time values within the time period predefined as valid and comparing the locally generated encoded TOTP codes to the received encoded TOTP to verify the TOTP is valid, i.e. the time of generation of the TOTP is valid.

In case the challenge and/or part thereof are used for generating the encoded TOTP, the authenticator 280 may also locally generate the encoded TOTP code(s) based on the challenge (or part thereof) and compare the locally generated encoded TOTP codes to the received encoded TOTP to verify the challenge information. As such the challenge information is further used as a signature to verify the encoded TOTP is generated in response to the (specific challenge) created by the authenticator 280 and sent to the (specific) code generation device 202 for the specific authentication process.

As shown at 312, the authenticator 280 calculates an authentication score for the user 240 using the client device 230 to access the secure service 260. The authenticator 280 calculates the authentication score based on the verification of the received encoded TOTP compared to the locally generated encoded TOTP and further according to the risk index extracted from the received encoded TOTP as calculated for the user 240 by the risk evaluator 222. As the authentication score is calculated based on the risk index estimating a risk level of the authentication process conducted by the user 240 to generate the TOTP, the authentication score may be indicative of genuineness, reliability and/or authenticity of the user 240.

Optionally, as described in step 110 of the process 100, in case the calculated authentication score exceeds a certain predefined risk threshold, the authenticator 280 may issue one or more requested instructing the user 240 to provide additional authentication information.

As shown at 314, the authenticator 280 calculates may output the calculated authentication score to one or more control systems adapted to grant the client device 230 access to the secure service 260 according to the authentication score calculated for the associated user 240. The control system(s) which may be part of the authentication system 204 and/or of the secure service 260, may provide the client device 230 full access, partial (limited) access or no access to the secure service based on the authentication score. One or more authentication level thresholds may be predefined which may be used by the control system(s) to grant and/or deny the client device 230 access to the secure service 260.

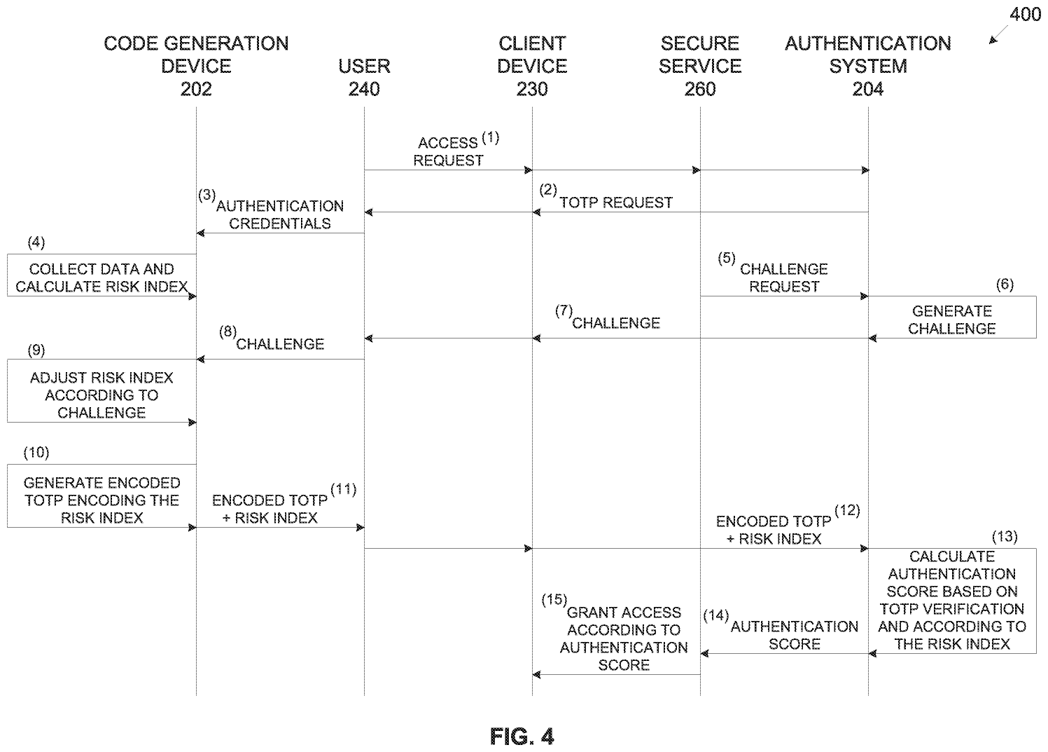

Reference is now made to FIG. 4, which is a schematic illustration of a sequence for generating a TOTP encoded with a risk index calculated to rate an authentication process of a user using a client device to access a secure service, according to some embodiments of the present invention. An exemplary sequence 400 presents a combined sequence of the processes 100 and 300 for calculating the risk index of the authentication process conducted by a user such as the user 240 to generate a TOTP for use by a client device such as the client device 230 to access a secure service such as the secure service 260 and the client device 230 granting access to the secure service 260 according to an authentication score calculated for the user 240 based on the risk index.

The sequence may typically start with the user 240 using his client device 230 to request access to the secure system 260 (1). In response, an authentication system such as the authentication system 204 associated with the secure service 260, specifically an authenticator such as the authenticator 280 may issue a request for a TOTP (2) as described in step 102 of the process 100. The user 240 may provide his authentication credentials (3) as described in step 102 of the process 100 to enable the code generation device 202 to generate the TOTP to be used for accessing the secure service 260. During the authentication process a risk evaluator such as the risk evaluator 222 may collect data relating to the authentication process as described in step 102 of the process 100 and calculate a risk index (4) aggregating the risk factors identified for the authentication process as described in step 106 of the process 100.

Optionally, the secure service 260 requests (5) the authenticator 280 to generate a challenge as described in step 104 of the process 100. The authenticator 280 may generate (6) the challenge comprising challenge information relating to the user 240, to client device 230 and/or to the code generation device 202 and transmit (7) the challenge to the client device 230 as described in step 104 of the process 100. The user 240 operating as a mediator may provide the challenge (8) to the risk evaluator 222 as described in step 104 of the process 100. In such case the risk evaluator 222 may adjust (9) the risk index according to a comparison of the collected during the authentication process to the challenge information as described in step 106 of the process 100.

The code generation device 202 may generate an encoded TOTP (10) as described in step 108 of the process 100 and output the encoded TOTP to the user 240 (11) who may transfer the encoded TOTP to the client device 230 for transmission (12) to the authenticator 280 as described in step 110 of the process 100.

The authenticator 280 may calculate an authentication score (13) based on verification of the encoded TOTP received from the code generation device 202 and according to the risk index extracted from the encoded TOTP as described in steps 310 and 312 of the process 300. The authenticator 280 may output the authentication score (14) to the secure service 260 which may grant access (15) to the client device 230 according to the authentication score as described in step 314 of the process 300.

It is expected that during the life of a patent maturing from this application many relevant systems, methods and computer programs will be developed and the scope of the term TOTP encoding schemes is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A computer implemented method of generating a Time based One Time Password (TOTP) comprising a risk assessment index, comprising:
using at least one processor of a code generation device for:
monitoring an authentication process in which a user provides authentication credentials to enable the code generation device to generate a TOTP for use by a client device associated with the user to access a secure service;
calculating a risk index indicating an estimated risk level of the authentication process based on data collected during the authentication process;
generating the TOTP based on a unique secret key assigned to the code generation device and a current time, the TOTP is encoded to encode the risk index; and
outputting the encoded TOTP for transmission to an authentication system adapted to generate an authentication score for the user attempting to access the secure service based on verification of the TOTP and according to the risk index.

2. The computer implemented method of claim 1, wherein the authentication credentials include at least one member of a group consisting of: a key, a code, an answer to a security question and a biometric verification.

3. The computer implemented method of claim 1, wherein the authentication process is conducted in response to a request from the authentication system to provide the TOTP.

4. The computer implemented method of claim 1, wherein the authentication process is conducted prior to a request from the authentication system to provide the TOTP.

5. The computer implemented method of claim 1, wherein the data collected during the authentication process comprising at least one member of a group consisting of: user information, device information relating to the code generation device, device information relating to the client device, timing information and interaction information relating to interaction of the user with the code generation device.

6. The computer implemented method of claim 1, further comprising generating the encoded TOTP in a machine readable representation.

7. The computer implemented method of claim 1, further comprising receiving a challenge from the authentication system, the challenge comprising data indicative of at least one attribute identified for at least one of: the user and the client device, the at least one attribute is available to the authentication system from at least one previous session conducted between the client device and the authentication system.

8. The computer implemented method of claim 7, further comprising calculating the risk index according to a comparison between the data collected by the code generation device during the authentication process and the data included in the challenge.

9. The computer implemented method of claim 7, further comprising generating the encoded TOTP based on at least some of the challenge data.

10. The computer implemented method of claim 7, further comprising the challenge is received in a machine readable representation.

11. The computer implemented method of claim 1, further comprising requesting the user to provide additional authentication information to the authentication system in case the risk index exceeds a predefined risk threshold.

12. A code generation device for generating a Time based One Time Password (TOTP), comprising:
a program store storing a code; and
at least one processor coupled to the program store for executing the stored code, the code comprising:
code instructions to monitor an authentication process in which a user provides authentication credentials to enable the code generation device to generate a TOTP for use by a client device associated with the user to access a secure service;
code instructions to calculate a risk index indicating an estimated risk level of the authentication process based on data collected during the authentication process;
code instructions to generate the TOTP based on a unique secret key assigned to the code generation device and a current time, the TOTP is encoded to encode the risk index; and
code instructions to output the encoded TOTP for transmission to an authentication system adapted to generate an authentication score for the user attempting to access the secure service based on verification of the TOTP and according to the risk index.

13. The code generation device of claim 12, wherein the code generation device is integrated in the client device.

14. A computer implemented method of authenticating a user attempting to access a secure service according to a Time based One Time Password (TOTP) comprising a risk assessment index, comprising:
using at least one processor of an authentication system for:
receiving an encoded TOTP from a client device associated with a user, the encoded TOTP is generated by a code generation device associated with the client device during an authentication process in which the user provides his authentication credentials to enable the code generating device to generate a TOTP for accessing a secure service, the TOTP which is based on a unique secret key assigned to the code generation device and a current time is encoded with a risk index to produce the encoded TOTP, the risk index calculated by the code generation device based on data collected from the client device is indicative of an estimated risk level of the authentication process;
decoding the encoded TOTP to extract the risk index and the TOTP;
calculating an authentication score based on verification of the TOTP and according to the risk index; and
outputting the authentication score to at least one system adapted to grant the client device access to the secure service according to the authentication score.

15. The computer implemented method of claim 14, wherein granting the client device access to the secure service includes one member of a group consisting of: granting full access, granting limited access and denying access.

16. The computer implemented method of claim 14, further comprising transmitting a challenge to the client device, the challenge comprising data indicative of at least one attribute identified for at least one of: the user and the client device, the at least one attribute is available to the authentication system from at least one previous session conducted between the client device and the authentication system, the challenge is used by the code generation device to calculate the risk index based on a comparison between the data collected from the client device and the data included in the challenge.

17. The computer implemented method of claim 16, further comprising transmitting the challenge in a machine readable representation.

18. The computer implemented method of claim 16, further comprising verifying the code generation device as originator of the encoded TOTP according to at least some of the challenge data used by the code generation device to generate the encoded TOTP.

19. The computer implemented method of claim 14, further comprising transmitting to the client device a request to provide additional authentication information in case the risk index exceeds a predefined risk threshold.

20. A system for authenticating a user accessing a secure service according to a Time based One Time Password (TOTP) comprising a risk assessment index, comprising:
a program store storing a code; and
at least one processor coupled to the program store for executing the stored code, the code comprising:
code instructions to receive an encoded TOTP from a client device associated with a user, the encoded TOTP is generated by a code generation device associated with the client device during an authentication process in which the user provides his authentication credentials to enable the code generating device to generate a TOTP for accessing a secure service, the TOTP which is based on a unique secret key assigned to the code generation device and a current time is encoded with a risk index to produce the encoded TOTP, the risk index calculated by the code generation device based on data collected from the client device is indicative of an estimated risk level of the authentication process;
code instructions to decode the encoded TOTP to extract the risk index and the TOTP;
code instructions to calculate an authentication score based on verification of the TOTP and according to the risk index; and
code instructions to output the authentication score to at least one system adapted to grant the client device access to the secure service according to the authentication score.
